(19) United States
(12) Patent Application Publication
(10) Pub. No.: US 2019/0097444 A1
(43) Pub. Date: Mar. 28, 2019

(54) Portable Charging Device

(71) Applicant: Global Shopping Network Pty Ltd., Sydney (AU)

(72) Inventor: Stephane Kljajic, Sydney (AU)

(21) Appl. No.: 16/204,016

(22) Filed: Nov. 29, 2018

Related U.S. Application Data
(63) Continuation of application No. 14/769,584, filed on Aug. 21, 2015.

(30) Foreign Application Priority Data
Feb. 22, 2013 (AU) 2013100194

(51) Int. Cl. H02J 7/00; A45C 11/00; A45C 3/06; H01M 2/10; A45C 15/00; A45C 13/02; H01M 10/48

(52) U.S. Cl. CPC H02J 7/0052; A45C 11/008; A45C 3/06; H02J 7/0047; H02J 7/0044; H02J 7/0054; H01M 10/488; A45C 15/00; H02J 7/0042; A45C 2011/002; H02J 2007/0062; A45C 13/02; H02J 2007/005; H01M 2/1005

(57) ABSTRACT

A clutch bag is described having a first lead adapted to convey charge between a charge store and a smartphone and between an external power source and the charge store. The charge store concealably and fittingly contained in a first compartment; a second compartment in which the smartphone can be removeably contained, wherein the charge store is adapted for direct electrical connection with a first end of the first lead, and when the charge store is to be charged, a second end of the first lead is electrically connected directly to an external power supply; and when the smartphone is to be charged, the second end of the first lead is electrically connected directly or through an adapter plug to the smartphone.

### FIELD OF THE INVENTION

The invention relates to a portable charging device for charging or recharging a portable electronic device. The portable charging device is most suitable for application in small carrying bags including handbags, clutch purses, pencil cases, purses, cosmetic or make-up compacts and cosmetic or make-up bags, small backpacks and the like.

### BACKGROUND OF THE INVENTION

Whilst the detailed discussion in this specification relating to optional or preferred embodiments of the present invention concerns clutch purses, it is to be understood that similar principles apply to handbags, pencil cases, cosmetic compacts, small backpacks and other small carrying bags.

When on brief trips outdoors or into town, such as for example to a nightclub or restaurant in an evening, ladies desire to travel light, with only those essential elements required for modern day socialising. The only items likely carried are small items such as cash, a credit card, an identification card, small cosmetic or make-up items, some small personal health items and smartphone.

There is often insufficient charge in a smartphone battery to last a full night's socialising and a recharge or external power supply is required to maintain an acceptable threshold of social contact with friends or even emergency contact with authorities. Mains power recharging is often not available.

The present invention provides a new portable charging or portable recharging device.

In this specification, where a document, act or item of knowledge is referred to or discussed, this reference or discussion is not an admission that the document, act or item of knowledge or any combination thereof was at the priority date:

known to be relevant to an attempt to solve any problem with which this specification is concerned.

Definitions: Plug throughout this specification and the claims which follow, refers to a male connector. Socket throughout this specification and the claims which follow, refers to a female connector.

### SUMMARY OF THE INVENTION

In accordance with a first aspect of the present invention there is provided a portable charging device for providing power to a portable electronic device, the portable charging device including:

a battery bag including at least two compartments, a first compartment being a battery compartment and a second compartment being a charging lead compartment in communication with one another by a charge lead aperture in a wall of the battery compartment;

a charge store in the form of a battery assembly, the battery assembly disposed inside the battery bag and including a first lead electrically connected to the battery and having a proximal end and a distal end for conveying charge between the battery and the portable electronic device during charging and/or discharging the battery, the lead including a distal plug at the distal end for electrical connection to a power outlet, the second plug being a multi-pin plug.

Preferably a second lead is provided which is electrically connected to the battery for conveying charge between the battery and the portable electronic device during charging and/or discharging the battery, the lead including a distal plug at the distal end for electrical connection to a power outlet, the second plug being a multi-pin plug.

Preferably an adaptor plug is provided for facilitating connection between a second end of the first or second lead to a different type of electronic device or power supply.

Optionally the multi-pin plug is any suitable plug, being a 1, 2, 3, 4, 5, 6, 7, 8, 9, 10, 11, 12, 13, 14, 15, 16, 17, 18, 19, 20, 21, 22, 23, 24, 25, 26, 27, 28, 29 or other pin plug. Preferably the plug is a Lightning plug by Apple, or a micro-USB plug.

Preferably the adaptor plug adapts between a micro-USB and a 30-pin plug, or a micro-USB and an 8-pin plug, or a USB to a 30-pin plug, or a USB to an 8-pin plug, or vice versa.

Preferably one or more extension leads are provided for connecting the distal end of the first and/or second leads to the electronic device or a power supply.

Preferably the extension lead includes a proximal socket at a proximal and a distal plug at the distal end, wherein the proximal socket and the distal plug do not cooperate with one another, so that a different electronic device can be connected to the distal end of the extension lead than to the proximal end of the first or second leads.

Preferably the proximal end of the first and second leads extends from the wall of the battery substantially parallel to the battery wall.

Preferably the battery bag includes detachable fasteners mounted thereto to detachably fasten to a small carrying bag including an opening, walls and a void accessible via the opening into which the battery bag is placed in use.

Preferably the cooperating removable fasteners are mounted adjacent the opening of the small carrying bag. Preferably the removable fasteners are press studs.

Preferably the carrying bag includes tags inside the bag on which cooperating removable fasteners are mounted.

Preferably the battery compartment includes a battery retainer so that the battery is retained in the battery compartment even when the battery compartment is open.

Preferably the battery retainer is a fastener which closes the battery compartment.

Preferably the battery bag includes an opening, the arrangement being such that the battery compartment is distal the opening and the lead compartment being proximal the opening.

Preferably the battery compartment is sealed so that the battery cannot be removed.

Preferably a charge indicator is provided to indicate charging status of the charge store. Preferably the charge indicator is disposed on a wall of the battery and is viewable through a viewing aperture or the lead aperture in the wall of the battery compartment. Preferably the viewing aperture includes reinforcing disposed about the perimeter of the aperture so as to inhibit tearing. Preferably the charge indicator is disposed on one of the leads or on one of the plugs so as to be viewable without peering inside the void of the small carrying bag.

Preferably the battery bag is mounted in the carrying bag such that a portable electronic device compartment is provided on one side of the battery bag and a storage compartment is provided in the bag on the other side of the battery bag for storage of other articles.

Preferably a battery loading opening and/or the opening of the lead compartment is releasably closable with a releasable fastener.

Preferably the battery compartment includes a lead aperture so that the second lead can extend outside the battery bag to inside the carrying bag, in the electronic device compartment when the battery bag is connected to the carrying bag. Preferably the lead aperture is at the base of the battery bag.

In accordance with another aspect of the present invention there is provided a portable charging for providing power to a portable electronic device, the portable power supply including:

a charge store in the form of a battery, the battery including

a battery bag including at least two compartments, a battery compartment and a portable electronic device compartment in communication with one another by a charge lead aperture in a wall of the battery compartment, the battery being disposed in the battery compartment in the small carrying bag, the portable electronic device compartment being configured to receive the portable electronic device;

a first lead for conveying charge between a first end and a second end during charging or discharging the battery, the lead including a first plug at the first end for electrical connection to the first charge socket of the battery, the plug being a multi-pin plug and a second plug at the second end for electrical connection an electronic device or power outlet the second plug being a multi-pin plug.

Preferably the multi-pin plugs are suitable and plugs such as 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30-pin plugs may be suitable, as are USB plugs, mini-USB plugs or micro-USB plugs.

Preferably the first lead is short to provide a compact and lightweight portable power supply apparatus to facilitate convenient carrying. Preferably the first lead is about 120 mm long so that the battery may be charged without being removed from the battery compartment. Preferably the second lead is short to provide a compact and lightweight portable power supply apparatus to facilitate convenient carrying. However, the second lead is preferably still long enough to provide use of the smartphone outside the clutch purse while connected to the battery. That is, preferably the second lead is about 100 mm long. It can be seen that the electronic device may also be used while the battery is being charged by being plugged into mains power.

Preferably the power supply includes a second charge socket disposed on a wall of the battery, the second charge socket configured to receive a charge plug.

Preferably each one of the first and second charge sockets disposed on the wall of the battery is in a form for cooperating with the plugs hereindescribed.

Preferably an adaptor plug is provided for facilitating connection between a second end of the first or second lead to a different type of electronic device or power supply.

Preferably the adaptor plug adapts between a micro-USB and a 30-pin plug, or a micro-USB and an 8-pin plug, or a USB to a 30-pin plug, or a USB to an 8-pin plug, or vice versa.

Preferably the power supply includes an extension lead for connecting the second end of the first or second leads to an electronic device.

Preferably the power supply includes an extension lead including a first socket at a first end and a second plug at the second end, wherein the first socket and the second plug do not cooperate with one another, so that a different electronic device can be connected to the second end of the extension lead than to the second end of the first or second leads.

Preferably the first plug at the first end of the first and second leads is configured so that the first end of the lead extends substantially parallel to the battery wall when the first plug is connected to the socket in the wall of the battery.

Preferably the first or second plug at the first end or second end of the first and second leads includes a substantially right-angle bend between socket and lead.

In accordance with another aspect of the present invention there is provided a portable power supply for providing power to a portable electronic device, the portable power supply including:

a charge store in the form of a battery;

a first lead having a first end integral with the battery at a selected lead outlet point on a wall of the battery, the first lead for conveying charge between the battery and a second end of the first lead;

a carrying bag including a battery compartment and a portable electronic device compartment in communication with one another by a charge lead aperture in a wall of the battery compartment, the battery being disposed in the battery compartment in the small carrying bag, the portable electronic device compartment being configured to receive the portable electronic device;

the first lead including a second plug at the second end for electrical connection to the first charge socket of the battery, the plug being a multi-pin plug.

Preferably the first lead extends along a wall of the battery upon its exit from the battery wall.

Preferably there is provided a second outlet lead integral with the battery at a selected lead outlet point on a wall of the battery, the second lead for conveying charge between the battery and a second end of the second lead.

Preferably there is provided a first charge socket disposed on a wall of the battery, the first charge socket configured to transfer charge to or from the battery and adapted to receive a charge plug on a lead, the charge plug adapted to cooperate with the first charge socket.

Preferably the battery compartment includes a double-walled leaf pocket so that a storage recess is formed on each side of the battery compartment, one compartment being the electronic device compartment for separate storage of the electronic device and the other compartment being a separate storage compartment. Preferably the battery compartment is closable with a zipper closure. Other closures are contemplated by the inventors for the battery compartment which may be suitable, including buttons, press studs, hook and loop fasteners. Preferably the two storage recesses are formed so that the smartphone may be disposed in one storage recess and other items may be stored in the other storage recess so that the screen of the smartphone is not scratched by the other items.

Preferably the battery compartment includes a battery loading opening for loading the battery. Preferably the battery is generally shaped as a rectangular prism about 5 to 10 mm thick, and about 60 to 100 mm wide and about 100 to 200 mm long. Preferably the battery compartment is several mm longer in each dimension than the preferred battery for secure battery positioning and ease of installation in the battery compartment.

Preferred dimensions for the small carrying bag are again a few mm longer in each dimension than the battery for compact carrying.

Preferably the battery loading opening is releasably closable with a releasable fastener. Preferably the releasable fastener is a zipper but may be hook and loop fasteners, ziplock, or other suitable fasteners.

Preferably the small carrying bag is in the form of a clutch purse, pencil case, cosmetic compact, or handbag. Preferably the battery compartment is removable from the small carrying bag. Preferably the battery compartment is a battery case which is removably fastened to the small carrying bag with suitable fasteners. Preferably the fasteners are press studs which cooperate with press stud mounts which are mounted on internal walls of the small carrying bag to facilitate release from the small carrying bag and easy reattachment.

Preferably a lead compartment is provided in communication with the battery compartment by a lead aperture. Preferably the lead aperture is in a rear wall of the lead aperture. Preferably the lead compartment is about 20 mm deep and extends separately from the battery compartment, adjacent its top edge, across the full width of the battery compartment which is about 100 mm long.

Preferably the battery compartment includes a battery retainer so that the battery is retained in the battery compartment even when the battery compartment is open.

Preferably the battery compartment is distal the battery loading opening and the lead compartment being proximal the battery loading opening.

Preferably the battery retainer is a fastener which closes the battery compartment. The closure may be any suitable closure including hook and loop fasteners, a retaining rib or pocket or wall or fabric return, although in one preferred embodiment the closure for the battery compartment is a thread sewn along the walls of the battery compartment to join opposed walls of the battery compartment together to as to seal the battery compartment from falling out while the battery compartment is open.

Preferably a charge indicator is provided to indicate charging status of the charge store. Preferably the charge indicator is disposed on a wall of the battery and is viewable through an aperture or the lead aperture in the wall of the battery compartment. The charge indicator may be disposed on one of the leads or on one of the plugs so as to be viewable without opening the small carrying bag.

Preferably the charge indicators are LED lights, though they may be other lights or screens or other indicating lamps. Preferably a plurality of LED lights are provided. Optionally the LED lights may be of suitable colours, whether each one of the LED lights is a single light frequency or whether each LED may selectively emit a light frequency under computer control.

In accordance with still another aspect of the present invention there is provided a kit of parts for assembly into a portable power supply for providing power to a portable electronic device, the kit of parts including:

a charge store in the form of a battery, the battery including
a first charge socket disposed on a wall of the battery, the first charge socket configured to receive a charge plug adapted to cooperate with the first charge socket, and

a carrying bag including a battery compartment and a portable electronic device compartment in communication with one another by a charge lead aperture in a wall of the battery compartment, the battery being disposed in the battery compartment in the small carrying bag, the portable electronic device compartment being configured to receive the portable electronic device;

a first lead for conveying charge between a first end and a second end during charging or discharging the battery, the lead including a first plug at the first end for electrical connection to the first charge socket of the battery, the plug being a 30-pin plug, a 19-pin plug, a USB plug or mini-USB plug, and a second plug at the second end for electrical connection an electronic device or power outlet, the second plug being a 30-pin plug, 19-pin plug, USB plug or mini-USB plug.

Preferably there is provided an extension lead for connecting the second end of the first lead to an electronic device, the extension lead includes a first socket at a first end and a second plug at the second end, wherein the first socket and the second plug do not cooperate with one another, so that a different electronic device can be connected to the second end of the extension lead than to the second end of the first or second leads.

The portable electronic device can be a communication device and may be a mobile phone, a smart phone, MP3 player, electronic diary or other like device.

Preferably the battery compartment is attached to the clutch purse at a base edge. Preferably the battery compartment is attached to the clutch purse at two side edges. Preferably the battery compartment is sewn into the clutch purse at the side edges, however, the battery compartment may just as easily be fastened in any other suitable way, including by press studs, buttons, hook and loop fasteners and the like.

According to another preferred embodiment of the invention, the sockets on the battery are USB sockets. Other charge inlet sockets are contemplated, including mini-USB, RCA, Ethernet, DIN, RJ-XX, Firewire, Lightning (by Apple), Thunderbolt (by Apple), 8-pin, 30-pin, and the like.

Preferably the second plug on the second end of the second lead for connection to a smartphone is a 30-pin plug of the type connectible to Apple Iphones of generations previous to the Iphone5. Optionally the plug is an 8-pin connector for an Iphone5, or a connector for connection to a Samsung, HTC, or any other smartphone. Optionally, the connectors are any suitable pin size, including 1, 2, 3, 4, 5, 6, 7, 9, 10, 11, 12, 13, 14, 15, 16, 17, 18, 19, 20, 21, 22, 23, 24, 25, 26, 27, 28, 29, 30 or more if required.

The access aperture is for providing access to the charge outlet cable without opening the battery compartment. Preferably the battery bag is constructed from fabric for inhibiting damage to the portable electronic device, including its screen; which can easily scratch.

Preferably the charge inlet cable is disposed within the battery compartment so that there is less mess inside the clutch purse during normal nighttime use.

Preferably the battery compartment is constructed from soft textile material so that when the smartphone is disposed within the clutch purse, the screen of the smartphone, against which the smartphone will rub, is not scratched.

According to a yet further form of the invention there is provided a portable power supply for providing power to a portable electronic device, the portable power supply including:

a charge store in the form of a battery adapted to be connected to a charge outlet lead; and

a clutch purse including a battery compartment, the battery being disposed in the battery compartment in the clutch purse.

The arrangement may be such that the portable electronic device compartment is configured to receive a portable electronic device while connected to the battery via the charge outlet lead.

The portable power supply may be in the form of a kit of parts wherein the battery, clutch purse and charge outlet cable are disposed in the kit and adapted to be connected to one another.

### BRIEF DESCRIPTION OF THE DRAWINGS

In order to enable a dearer understanding, the invention will now be further explained and illustrated by reference to the accompanying drawings in which:

FIG. 1 is a side elevation view of a portable power supply in accordance with a preferred embodiment of the present invention;

FIG. 2 is a perspective plan view of the portable power supply shown in FIG. 1, wherein a clutch purse which is part of the portable power supply and houses a battery is open to show a re-sealable battery compartment and two storage recesses disposed on either side thereof;

FIG. 3 is a perspective plan view of the portable power supply shown in FIG. 1, wherein the clutch purse and the re-sealable battery compartment are both open;

FIG. 4 is a front elevation view of a charge store in the form of a battery assembly which is a suitable component in a preferred embodiment of the present invention;

FIG. 5 is a perspective view of a battery bag which has been removed from a small carrying bag, the battery bag being open at an opening, shown an open lead compartment disposed adjacent a sealed battery compartment;

FIG. 6 is a front elevation view of a battery bag which has been removed from a small carrying bag, the battery bag showing the partially closed lead compartment and sealed battery compartment, and one of the leads, being for charging the charge store, extending through a lead aperture; and

FIG. 7 is a front elevation view of another battery assembly for use as a component in another preferred embodiment of the present invention.

### DETAILED DESCRIPTION OF PREFERRED EMBODIMENTS

Referring to the drawings there is shown a portable charging device generally indicated at 10, the portable charging device 10 including a charge store 12 in the form of a battery assembly 14 including a charge outlet lead 16 electrically connected to a battery surrounded by a battery case. The electrical connection between the leads and the battery may be permanent (being integral) or via an electrical socket The electrical socket 189 may be a USB socket, a micro-USB socket, a mini-USB socket, a Lightning socket or other multi-pin socket, being 1, 2, 3, 4, 5, 6, 7, 8 9, 10, 11, 12, 13, 14, 15, 16, 17, 18, 19, 20, 21, 22, 23, 24, 25, 26, 27, 28, 29 or 30 pin sockets.

The portable charging device 10 further includes a clutch purse 18 including a battery compartment 20, the battery assembly 14 being disposed in the battery compartment 20 in the clutch purse 18. The portable charging device 10 is suitable for charging a smartphone 5.

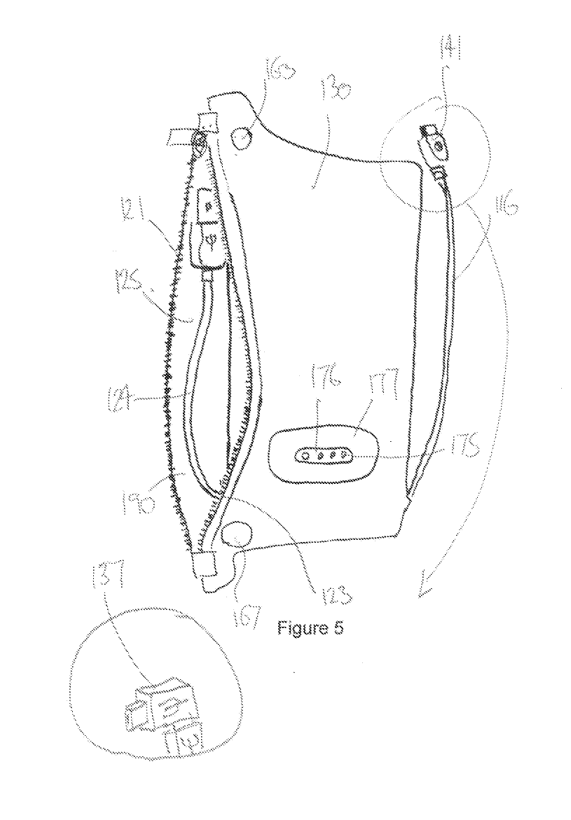

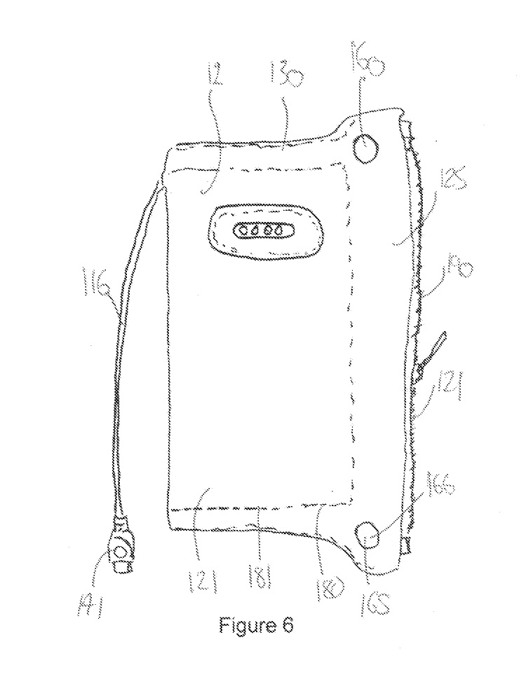

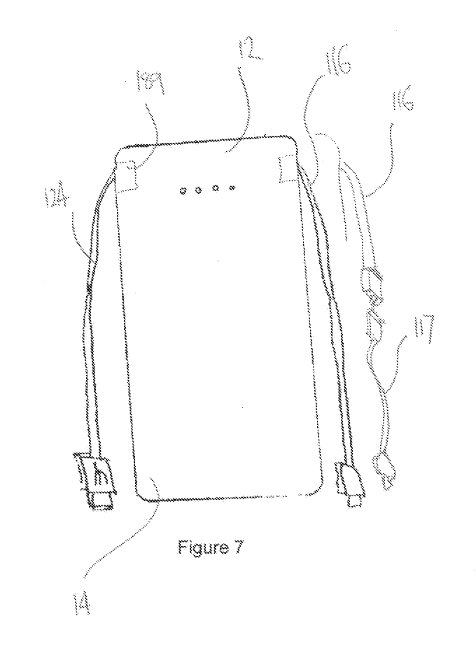

The battery assembly 14 includes a charge inlet 22. The charge inlet 22 includes a charge inlet socket 189 (in FIG. 7 on a separate embodiment, but these may not always be present, since the leads may be hardwired to the battery). The battery 14 further includes a charge inlet lead 24 including a charging plug 26 at a distal end 28 to connect the charge inlet socket (not shown) on the battery 14 to another kind of power outlet, say, a micro-USB, USB, Lightning, or other kind of multiple pin connector. The charge inlet lead 24 may be disposed in the battery compartment 20 with the battery but in selected embodiments such as those shown in FIGS. 5 and 6 the charge inlet lead 24 when not connected to a GPO resides in a separate lead compartment 125 which is connected to the battery compartment 20 by a charge lead aperture 123. The charge lead aperture 123 in FIGS. 5 and 6 is disposed at the base of the charge lead compartment 125 at one end and is of a selected length so as to keep the charge lead extending flat along the base of the charge lead compartment 125 from one end to the other when the charge lead is not connected to the USB power supply.

The battery 14 in the embodiment shown includes a charge inlet lead 24 which is integral with the battery 14.

The charge inlet lead 24 is short in the embodiment shown to provide a compact and lightweight portable power supply apparatus to facilitate convenient carrying. The charge inlet lead 24 is about 100 mm long so that the battery may be charged without being removed from the battery compartment.

The charge outlet lead 16 is also short, about 120 mm long, to provide a compact and lightweight portable power supply apparatus to facilitate convenient carrying. The charge outlet lead 16 is also still long enough to provide easy connection of the smartphone 5 outside the clutch purse and operation of the phone while connected to the battery 14.

The battery compartment 20 is closable, and in the embodiment shown is closable with a zipper closure 21. Other closures are contemplated by the inventors for the battery compartment which may be suitable, including buttons, press studs, hook and low fasteners.

The battery compartment 20 provides a leaf inside the clutch 18, the leaf comprising two walls 30, 32 sewn together so that storage recesses 34, 35 are formed on each side of the battery compartment 20. The two storage recesses 34, 35 are formed so that the smartphone 5 may be disposed in one storage recess 34 and other items may be stored in the other storage recess 35 so that the screen of the smartphone is not scratched by the other items (not shown).

The battery compartment 20 is attached to the clutch purse at a base edge 38. The battery compartment 20 is attached to the clutch purse 18 at two side edges 37, 39. The battery compartment 20 is sewn into the clutch purse at the side edges 37, 39, however, the battery compartment 20 may just as easily be fastened in any other suitable way, including by press studs, buttons, hook and loop fasteners and the like. An alternative embodiment has press studs 165 holding the battery compartment in place in the clutch 18.

The charge inlet sockets, when provided (they are shown in FIG. 7), are USB sockets. Other charge inlet sockets are contemplated, including micro-USB, mini-USB, RCA, Ethernet, DIN, RJ-XX, Firewire, Lightning, Thunderbolt and the like. The sockets may be disposed along one edge or opposite edges, depending on whether a user may like to plug their lead in from the front or at the rear of the battery.

The plug 40 on the charge outlet lead 16 for connection to the smartphone 5 is a 30-pin plug 41 of the type connectible to Apple Iphones of generations previous to the Iphone5. Optionally the plug is an 8-pin connector for an Iphone5, or a connector for connection to a Samsung, HTC, or any other smartphone.

The clutch purse 18 is closable by any suitable means being clips, buttons, zippers, hook and loop fasteners, buckles and the like. In the embodiment shown the clutch purse 18 is closable by a zipper 19.

The battery compartment 20 includes an access aperture 42 for the charge outlet lead 16. The access aperture 42 is disposed in wall 30 of the battery compartment 20. The access aperture 42 is for providing access to the charge outlet lead 16 without opening the battery compartment zipper 21 so that the battery will not fall out or be damaged during powering or charging the smartphone 5.

As mentioned, the charge inlet cable is disposed in use within the battery compartment 20 so that there is less mess inside the clutch purse 18 during normal night-time use (ie when not charging). Alternatively the inlet cable can reside in a separate charge cable compartment adjacent the zipper 21 as shown in FIGS. 5 and 6, for easy extraction of the cable from the compartment.

The battery compartment 20 is constructed from soft textile material 45 so that when the smartphone 5 is disposed within the clutch purse 18, the screen of the smartphone 5, against which the smartphone will rub during carrying, is not scratched.

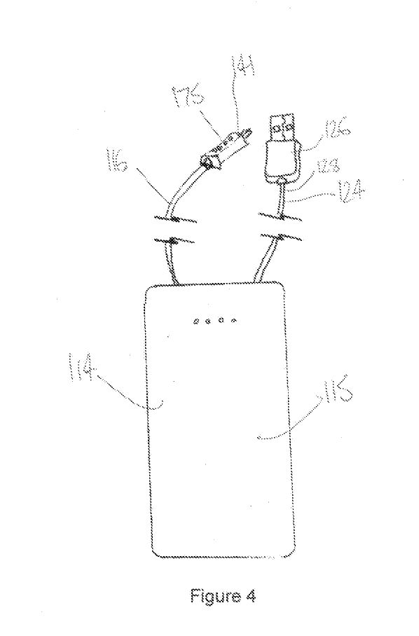

Referring to FIGS. 4 to 7 there are shown similar features described in other embodiments above, with similar numerals denoting them, though there are some differences. So there is shown a portable charging device 110 for providing power to a portable electronic device 5, the portable charging device 110 including a battery bag 130 including at least two compartments 120, a first compartment being a battery compartment 121 and a second compartment being a charging lead compartment 125 in communication with one another by a charge lead aperture in a wall of the battery compartment 120; a charge store 112 in the form of a battery assembly 114, the battery assembly 114 disposed inside the battery bag 130 and including a first lead 124 electrically connected to the battery assembly 114 and having a proximal end and a distal end for conveying charge between a battery 115 and the portable electronic device 5 during charging and/or discharging the battery, the lead 122 including a distal plug 126 at the distal end 128 for electrical connection to a power outlet, the distal plug 126 being a multi-pin plug.

A second lead 116 is electrically connected to the battery 115 for conveying charge between the battery 115 and the portable electronic device during charging and/or discharging the battery 115, the second lead 116 including a distal plug 141 at the distal end for electrical connection to an electrical device, the second plug 141 being a multi-pin plug.

An adaptor plug is shown at 133 for facilitating connection between a second end of the first lead to a different type of electronic device or power supply. Another adaptor plug 137 is shown in FIG. 5, which is a right-angle plug so that the electronic device does not bend the cable 116.

Each one of the multi-pin distal plug 141 and the multi-pin distal plug 126 is any kind of suitable plug, being a 1, 2, 3, 4, 5, 6, 7, 8, 9, 10, 11, 12, 13, 14, 15, 16, 17, 18, 19, 20, 21, 22, 23, 24, 25, 26, 27, 28, 29 or other pin plug. The plug in preferred embodiments is a Lightning plug by Apple, or a micro-USB plug for connection to Samsung and other like phones.

The adaptor plugs 33 and 137 adapt between any one of the suitable multi-pin plugs 141 and 126 and any other. But preferably the plugs adapt between micro-USB and a 30-pin plug, or a micro-USB and an 8-pin plug, or a USB to a 30-pin plug, or a USB to an 8-pin plug, or vice versa.

One or more extension leads 117 are provided for connecting the distal plugs of the first and/or second leads 141, 133 to the electronic device or a power supply. The extension leads are provided so that the phone 5 may be charged outside the clutch purse. Overall, the leads are about the length of the battery. The extension lead can either include a proximal socket at a proximal and a distal plug at the distal end, wherein the proximal socket and the distal plug do not cooperate with one another, so that a different electronic device can be connected to the distal end of the extension lead than to the proximal end of the first or second leads. That is, the proximal end may be micro-USB and the distal end may be 8-pin. Alternatively the two ends may cooperate, and may be micro-USB.

The proximal end of the first and second leads extends from the wall of the battery along one side, substantially parallel to the battery wall so as to reduce the width and bending of the cables 116, 124.

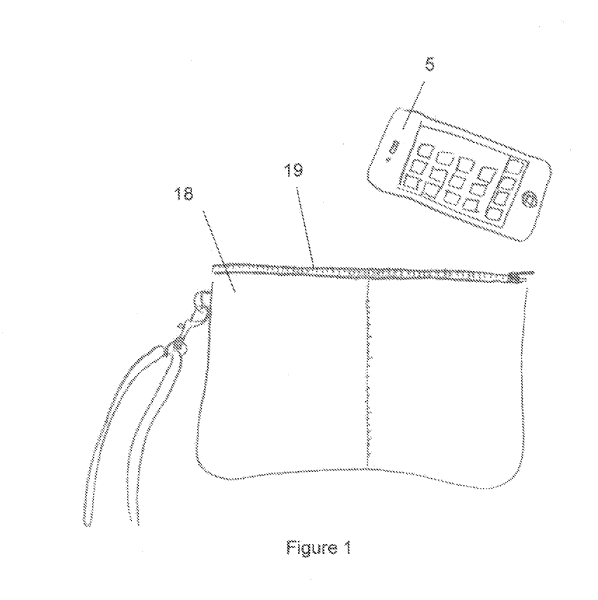

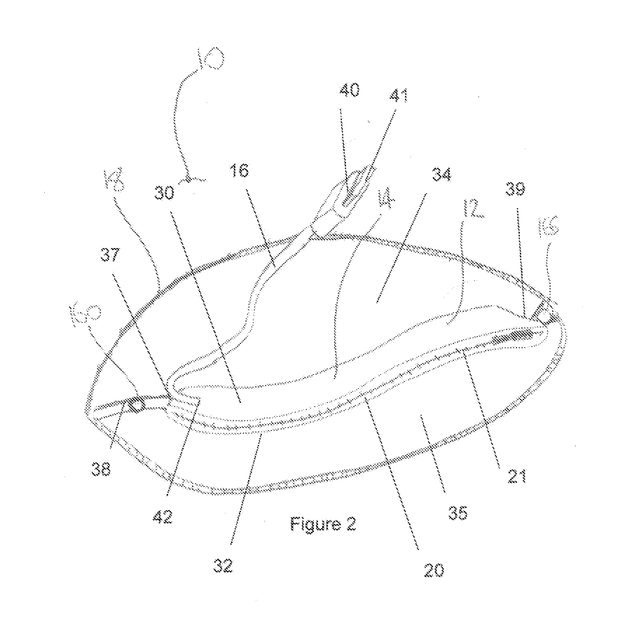

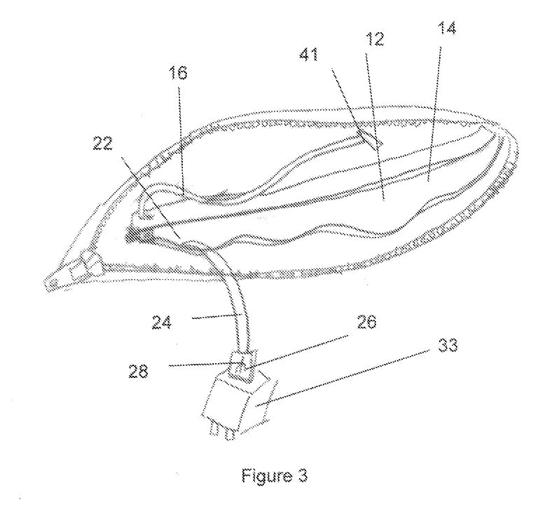

The battery bag includes detachable fasteners 160 mounted thereto to detachably fasten to a small carrying bag 18 in the same way as described and shown in FIGS. 1 to 3.

Cooperating removable fasteners 165 are mounted adjacent the opening of the small carrying bag 118. The removable fasteners 165 are press studs 167 but may be hook and loop fasteners. The carrying bag 118 includes tags 169 inside the bag on which the cooperating removable fasteners 166 are mounted. Alternatively the press studs can be mounted straight on the wall of the carrying bag, a clutch purse 118.

The battery compartment 121 includes a battery retainer 180 so that the battery is retained in the battery compartment 121 even when the battery compartment zipper 129 is open. The battery retainer is a fastener 181 which closes the battery compartment 121, the fastener 181 being a seal in the form of a stitched compartment 121.

The battery bag 130 includes an opening 190, the arrangement being such that the battery compartment 121 is distal the opening 190 and the lead compartment 125 being proximal the opening 190.

A charge indicator 175 is provided to indicate charging status of the charge store 112. The charge indicator 175 is disposed on a wall of the battery 115 and is viewable through a viewing aperture 176 in the wall of the battery compartment. The viewing aperture 176 includes reinforcing 177 disposed about the perimeter of the aperture so as to inhibit tearing. The charge indicator can be disposed on one of the leads 124 or on one of the plugs 126 so as to be viewable without peering inside the void of the small carrying bag 118. The charge indicators are LED lights, though they may be other lights or screens or other indicating lamps. A plurality of LED lights are provided, in the case shown, there are four. The LED lights may be of suitable colours, whether each one of the LED lights is a single light frequency or whether each LED may selectively emit a light frequency under computer control.

The battery bag is mounted in the carrying bag such that a portable electronic device compartment 134 is provided on one side of the battery bag and a storage compartment 135 is provided in the bag on the other side of the battery bag for storage of other articles. (As described herein in regard to FIGS. 1 to 30

The battery loading opening and/or the opening of the lead compartment is releasably closable with a releasable fastener, the zipper 129.

The battery compartment includes a lead aperture 142 so that the second lead can extend outside the battery bag to inside the carrying bag, in the electronic device compartment 135 when the battery bag is connected to the carrying bag 118. The lead aperture 142 is at the base of the battery bag 130.

The word ‘comprising’ and forms of the word ‘comprising’ as used in this description and in the claims do not limit the invention claimed to exclude any variants or additions. Modifications and improvements to the invention will be readily apparent to those skilled in the art. Such modifications and improvements are intended to be within the scope of this invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-27. (canceled)

28. A clutch bag that charges and/or recharges a smartphone with a charge store in the form of a battery assembly and without the clutch bag being electrically connected directly or indirectly to an external power source, the clutch bag including a first lead adapted to convey charge between the charge store and the smartphone and between an external power source and the charge store, the clutch bag comprising:
a. the charge store concealably and fittingly contained in a first compartment; and
b. a second compartment in which the smartphone can be removeably contained, wherein the charge store is adapted for direct electrical connection with a first end of the first lead, and:
when the charge store is to be charged, a second end of the first lead is electrically connected directly to an external power supply; and
when the smartphone is to be charged, the second end of the first lead is electrically connected directly or through an adapter plug to the smartphone.

29. The clutch bag of claim 28, wherein an aperture provides communication between the first compartment and the second compartment, and the first lead extends, or can be extended, through the aperture.

30. The clutch bag of claim 28, further including at least one adaptor plug, with each adaptor plug adapted to electrically connect with a smartphone that has a correspondingly shaped and/or pinned electrical connections.

31. The clutch bag of claim 28, wherein a charge indicator is provided, viewable through a viewing aperture, to indicate charge status of the charge store.

32. The clutch bag of claim 28, wherein the charge store is removeably contained in the first compartment.

33. The clutch bag of claim 28, wherein one or more of the electrical connections is releaseable.

34. The clutch bag of claim 28, wherein the smartphone can be used while being charged and/or recharged.

35. A clutch bag that provides an electric charge to a smartphone, the clutch bag comprising:
a first lead;
a charge store, in the form of a battery assembly, concealably and fittingly contained in a first compartment, the charge store including at least one USB port and at least one multi-pin port; and
a second compartment in which the smartphone can be removeably contained,
wherein:
the charge store is connected directly to an external power supply by the first lead when the charge store is to be charged; and
the smartphone is connected directly or through an adapter plug to the charge store by the first lead when the smartphone is to be charged.

36. The clutch bag of claim 35, wherein an aperture provides communication between the first compartment and the second compartment, and the first lead extends, or can be extended, through the aperture.

37. The clutch bag of claim 35, further including at least one adaptor plug, with each adaptor plug adapted to electrically connect with a smartphone that has correspondingly shaped and/or pinned electrical connections.

38. The clutch bag of claim 35, wherein a charge indicator is provided, viewable through a viewing aperture, to indicate charge status of the charge store.

39. The clutch bag of claim 35, wherein the charge store is removeably contained in the first compartment.

40. The clutch bag of claim 35, wherein one or more electrical connections is releaseable.

41. The clutch bag of claim 35, wherein the smartphone can be used while being charged and/or recharged.

42. A clutch bag that charges and/or recharges a smartphone with a charge store in the form of a battery assembly and without the clutch bag being electrically connected directly or indirectly to an external power source, the clutch bag including a first lead adapted to convey charge between the charge store and the smartphone and between an external power source and the charge store, the clutch bag comprising:
a. the charge store concealably, removably and fittingly contained in a first compartment;
b. a second compartment in which the smartphone can be removeably contained;
c. an aperture providing communication between the first compartment and the second compartment and through which the first lead passes;
d. at least one adaptor plug, with each adaptor plug adapted to electrically connect with a smartphone that has correspondingly shaped and/or pinned electrical connections;
e. a charge indicator, viewable through a viewing aperture, to indicate charge status of the charge store;
wherein one or more electrical connections is releaseable, and the charge store is adapted for direct electrical connection with a first end of the first lead, and:
when the charge store is to be charged, a second end of the first lead is electrically connected directly to an external power supply; and
when the smartphone is to be charged, the second end of the first lead is electrically connected directly or through an adapter plug to the smartphone, and the smartphone can be used while being charged and/or recharged.
